(19) United States
(12) Patent Application Publication
(10) Pub. No.: US 2019/0193075 A1
(43) Pub. Date: Jun. 27, 2019

(54) SAMPLE CONTAINER FOR A CRYOGENICALLY PRESERVED BIOLOGICAL SAMPLE, METHOD FOR PRODUCING THE SAMPLE CONTAINER, METHOD FOR MONITORING THE TEMPERATURE OF A CRYOGENICALLY PRESERVED SAMPLE

(71) Applicant: Fraunhofer-Gesellschaft zur Foerderung der angewandten Forschung e. V., Muenchen (DE)

(72) Inventors: Guenter R. FUHR, Berlin (DE); Heiko ZIMMERMANN, Waldbrunn (DE)

(21) Appl. No.: 16/097,111

(22) PCT Filed: Mar. 31, 2017
(86) PCT No.: PCT/EP2017/000406

§ 371 Date: Oct. 26, 2018

(30) Foreign Application Priority Data
Apr. 27, 2016 (DE) 10 2016 005 077.2

(51) Int. Cl. B01L 3/00; A01N 1/02; G01N 1/42; G01K 11/06; G01K 3/04

(52) U.S. Cl. CPC B01L 3/50851; A01N 1/0268; G01N 1/42; G01K 11/06; B01L 2300/1894; B01L 2200/147; B01L 2200/143; B01L 2300/021; G01K 3/04

(57) ABSTRACT

The invention relates to a sample container that is designed to accommodate a cryogenically preserved biological sample, and to a method for producing the sample container. The invention further relates to a method for monitoring the temperature of a cryogenically preserved biological sample. The sample container that is designed to accommodate a cryogenically preserved biological sample has, on a region of its outer surface, a frozen-solid indicator substance whose melting point is in a range from −20° C. to −140° C.

The invention relates to a sample container which is configured to receive a cryopreserved biological sample and a method for producing the sample container. The invention further relates to a method for temperate monitoring of a cryopreserved biological sample.

The low-temperature preservation (cryopreservation) of cells is hitherto the only possibility of stopping vital processes reversibly (maintaining vitality) at a cellular level such that they can restart after heating to physiological temperatures. Cryopreservation has developed by way of large biobanks in recent decades to become an essential element for clinics, pharmaceutical companies, species survival, environmental protection and health provision. Biological material is stored in low-temperature-compatible sample containers (cryogenic containers), e.g. tubes, straws and bags, of various sizes. In the case of cryopreservation, the stored biomaterial is frozen while maintaining the vitality of the sample material, usually at temperatures below −80° C., for living collections below −140° C. to the temperature of liquid nitrogen. The term “cryogenic sample” is also used below for a cryopreserved sample or a sample intended for cryopreservation.

Numerous techniques have been developed for macroscopic samples, such as e.g. blood or tissue, for sample storage at low temperatures. There is a tendency in modern medicine, genetic engineering and biology to increasingly subject small samples to cryopreservation. For example, small suspension volumes (milliliter or below) with suspended cells or groups of cells are frozen. The cryopreservation of cells from in-vitro cultures is primarily carried out in a suspension. However, the majority of biomedically significant cells require a substrate contact for their propagation and proper development. Samples are therefore frozen in the substrate-bound state possibly after cultivation.

The quality of the samples is of decisive importance since they are used for cell therapies in clinics, the development of pharmaceuticals and biotechnological products, as national resources and many other things. The storage time varies from a few days up to decades, with a tendency towards long-term storage. The samples are stored in cooled containers, are usually located in metal drawers and racks, with which they are subjected to temperature fluctuations in the case of new deposits or removals. In the case of living storage (cells, cell suspensions and pieces of tissue), it is not only the uninterrupted cooling chain which plays a vital role, but also the avoidance of large jumps in temperature in the deep-freezing phase. Since it is not unknown during removal for cryogenic containers to heat up to temperatures of −80° C. to −20° C., despite the fact they are still frozen, reductions in quality unknowingly arise which not only reduce the value of the sample, but can also lead to life-threatening situations when they are used in the clinical sector. Even if samples have only thawed briefly, it is not possible to see in the refrozen state that they no longer match the original condition. However, it is especially important to not only identify a thawing of the biomaterial, but also to document the exceeding of a threshold temperature in the range between −140° C. and −20° C. Temperature control and documentation for each sample is the requirement, one which has hitherto only seldom been satisfied, and if so, with high technical outlay. One must also remember extensive laboratory tests after thawing which also use valuable sample material and generate costs even in the case of cryogenic samples which have become worthless in the interim.

One object of the invention is thus to provide a sample container for a cryopreserved sample which is suitable for temperature monitoring of a cryopreserved biological sample. A further object is to indicate a method for producing such a sample container. A further object is to provide a method for temperature monitoring of a cryopreserved biological sample, with which disadvantages of conventional techniques can be avoided and which is characterized by a simplified execution of the method.

A further object is to provide a possibility in order to be able to identify from as simple as possible a marker whether a cryogenic sample has been heated above a definable threshold temperature, even if only for a short time. It must be possible to fix the threshold temperature in the range between −20° C. and 140° C. prior to freezing. This should be possible quickly and in a readily apparent manner at each individual cryogenic sample and at thus millions of samples, must not change the biomaterials and should already be carried out in the deep-frozen state. If possible it should be possible to detect the condition of the sample even in the storage container since every time the sample is removed from and returned to storage there is the risk of a change in sample of a plurality of samples in the store since entire racks are generally pulled up. The device and the method should be easy to handle, low-temperature-tolerant and adjustable. It must consume no or only a small amount of energy and result in only the smallest of costs since the storage of a biological sample in the cooled state should only cost a few Euros in terms of total outlay. The materials used must also satisfy this requirement.

These objects are achieved by devices and methods with the features of the independent claims. Advantageous embodiments and applications of the invention will become apparent from the dependent claims and are explained in greater detail in the following description with partial reference to the figures.

According to a first aspect of the invention, the stated objects are achieved by a sample container which is configured to receive a cryopreserved biological sample and which bears at a region of its outer surface a frozen-solid indicator substance, the melting temperature of which at normal pressure, i.e. at 1013.25 hPa, lies in a range from −20° C. to −140° C. The melting temperature may also lie in a range from −20° C. to −100° C. As a result of this, a sample container is provided which is configured for a temperature monitoring of a cryopreserved biological sample.

The sample container is a container which is suitable for cryopreservation, for example, a tube, a straw (also referred to as a seed tube), a bag for blood or stem cell storage, a box or another container which is suitable for cryopreservation. Such containers are correspondingly also referred to as cryogenic tubes, cryogenic straws, cryogenic bags, cryogenic boxes or generally as cryogenic containers. The sample container has a receiving space for receiving the biological samples. The receiving cavity may contain a cryopreserved sample.

Cryogenic tubes are also referred to as biobank or cryobank tubes. Cryogenic tubes have a receiving space which forms an inner cavity for receiving a biological sample. The cryogenic tube furthermore normally has a cover for closing off the receiving space. The cover can have an engagement via which the cover can be rotated with a tool. The cryogenic tube can also have a base element which has a marking, e.g. in the form of machine-readable code.

In the event of exceeding of the melting temperature, the frozen-solid indicator substance becomes liquid. A configuration state of the indicator substance on the outer surface of the sample container subsequently changes, e.g. as a result of gravity and/or surface tension. For example, the indicator substance can, upon exceeding its melting point, change the position on the sample container and/or its surface form, which can be determined visually or by a measuring apparatus. The change in the configuration state is also maintained in the event of refreezing of the indicator substance. The indicator substance which is frozen-solid at a region of the outer surface of the sample container thus preferably has a configuration, the form and/or arrangement of which change(s) in the event of exceeding of a melting temperature of the indicator substance.

A sample container which bears at a region of its outer surface a frozen-solid indicator substance, the melting temperature of which lies in a range from −20° C. to −140° C., may thus advantageously be used for temperature monitoring of a cryopreserved biological sample. The sample container according to the invention can furthermore be produced at low cost and requires less additional installation space in comparison with a conventional sample container.

The indicator substance may thus be applied directly on an outer surface of a sample container. The indicator substance may be fastened to an outer surface of the sample container exclusively by freezing solid, i.e. the indicator substance is not retained on the sample container by further fastening elements, such as an additional vessel, etc. The indicator substance may be frozen solid exposed on the container.

For the purpose of improved detectability, the indicator substance many contain an indicator additive which improves detectability of a physical property of the indicator substance. The indicator additive may be, for example, a dye so that the indicator substance is colored or dyed, i.e. not transparent, and thus its shape and/or location is optically better apparent.

In principle, any dye which satisfies at least the following conditions is possible as a dye:
intensive dyeing capacity even in small quantities and concentrations (e.g. starting from a saturated dye solution addition in the range <1% by volume, generally in the parts-per thousand or sub-parts-per-thousand range).
frost-tolerant
lightfast at the dispatch temperatures and also the relevant low temperatures
soluble in all components of the indicator substance
no separation during freezing
no reaction with plastic materials which come into contact with the indicator substance.

The dye is preferably selected from the group which comprises triphenylmethane dyes, rhodamine dyes, in particular xanthene, azo dyes as well as phenazine and phenothiazine dyes.

In more specific embodiments, the dye is selected from the group which comprises oil red, methyl red, brilliant green, rhodamine B, neutral red, methylene blue or other dyes which are used to dye cells in cytology.

The indicator additive can be particles, in particular nanoparticles which increase a scattering action and/or polarization action of the indicator substance for electromagnetic radiation striking the indicator substance. As a result, a change in configuration of the indicator substance can be detected more reliably by means of optical transmission measurement, scattering measurement and/or polarization measurement. The indicator additive can be conductive particles. The conductivity or impedance of the indicator substance can be influenced by adding conductive particles. In this manner, a change in configuration of the indicator substance can be detected by means of a conductivity measurement or impedance measurement.

A substance, the melting temperature of which corresponds to a predetermined threshold temperature, the exceeding of which should be monitored, can be selected as the indicator substance. The indicator substance is a liquid or a mixture of different liquids, the melting point of which corresponds to the desired threshold temperature. Merely by way of example, a mixture of water (H₂O) and ethanol (C₂H₆O), a mixture of water (H₂O) and potassium hydroxide (KOH) or a mixture of water and an antifreeze can be selected as the indicator substance. The mixture ratio is adjusted according to the respective melting diagram which indicates the profile of the melting point as a function of the mixture ratio so that the melting point of the liquid mixture has the desired value, namely the threshold temperature to be monitored.

According to one preferred embodiment, the indicator substance comprises at least one alcohol which is selected from the group which comprises octan-1-ol, nonan-1-ol, propane-1,2-diol, propane-1,3-diol, butane-1,2-diol, butane-1,3-diol, butan-2-ol, pentane-1,5-diol, pentan-1-ol, cyclopentanol, benzyl alcohol. The at least one alcohol is particularly preferably selected from propane-1,3-diol, propane-1,2-diol and butan-2-ol.

According to another preferred embodiment, the indicator substance comprises at least two different alcohol components:

a) an alcohol selected from the group which comprises octan-1-ol, nonan-1-ol, propane-1,2-diol, propane-1,3-diol, butane-1,2-diol, butane-1,3-diol, butan-2-ol, pentane-1,5-diol, pentan-1-ol, cyclopentanol, benzyl alcohol;

b) an alcohol selected from the group which comprises octan-1-ol, nonan-1-ol, propane-1,2-diol, propane-1,3-diol, butane-1,2-diol, butane-1,3-diol, butan-2-ol, pentane-1,5-diol, pentan-1-ol, cyclopentanol, benzyl alcohol with a lower melting point than the alcohol of component a);

wherein the mixing ratio of components a) and b) is adjusted so that the melting temperature of the mixture lies within a temperature range from −20° C. to −160° C., in particular from −25° C. to −160° C. or −50° C. to −150° C.

More specific embodiments are characterized in that the indicator substance comprises one of the following combinations of components a) and b):
octan-1-ol and butan-2-ol in a mixture ratio of 5% to 95% by volume;
octan-1-ol and pentan-1-ol in a mixture ratio of 5% to 95% by volume;
octan-1-ol and propane-1,2-diol in a mixture ratio of 5% to 95% by volume;
nonan-1-ol and butan-2-ol in a mixture ratio of 5% to 95% by volume;
nonan-1-ol and propane-1,2-diol in a mixture ratio of 5% to 95% by volume;
nonan-1-ol and pentan-1-ol in a mixture ratio of 5% to 95% by volume;
propane-1,2-diol and butan-2-ol in a mixture ratio of 5% to 95% by volume;
propane-1,2-diol and propane-1,3-diol in a mixture ratio of 5% to 95% by volume;
propane-1,2-diol and butane-1,2-diol in a mixture ratio of 5% to 95% by volume;
propane-1,3-diol and butan-2-ol in a mixture ratio of 5% to 95% by volume;
propane-1,3-diol and butane-1,2-diol in a mixture ratio of 5% to 95% by volume;
pentane-1,5-diol and butan-2-ol in a mixture ratio of 5% to 95% by volume;
benzyl alcohol and butan-2-ol in a mixture ratio of 5% to 95% by volume;
pentan-1-ol and butan-2-ol in a mixture ratio of 5% to 95% by volume;
pentan-1-ol and methanol in a mixture ratio of 5% to 95% by volume;
cyclopentanol and butan-2-ol in a mixture ratio of 5% to 95% by volume;
cyclopentanol and propane-1,2-diol in a mixture ratio of 5% to 95% by volume;
cyclopentanol and pentan-1-ol in a mixture ratio of 5% to 95% by volume;
cyclopentanol and butane-1,2-diol in a mixture ratio of 5% to 95% by volume;

wherein the indicated value of the mixture ratio relates in each case to the ratio of the former component in the mixture of both components.

According to particularly preferred embodiments, this indicator mixture comprises, for example, propane-1,2-diol and butan-2-ol in a mixture ratio of 40% to 60% by volume (produces a melting temperature of approx. −90° C.), propane-1,2-diol and propane-1,3-diol in a mixture ratio of 30% to 70% by volume, or propane-1,3-diol and butan-2-ol in a mixture ratio of 30% to 70% by volume.

The indicator substance preferably also comprises, in addition to the at least one alcohol, at least one dye as described above. This dye is particularly preferably selected from the group which comprises oil red, methyl red, brilliant green and rhodamine B.

An even more specific embodiment is characterized in that the indicator substance comprises two alcohols a) and b), which are selected from propane-1,3-diol, propane-1,2-diol and butan-2-ol, preferably in a mixture ratio as indicated above, as well as a dye which is selected from the group which consists of oil red, methyl red, brilliant green and rhodamine B.

The concentration of the dye in the alcohol component can vary greatly depending on the dye and alcohol.

In the case of intensive coloring, the concentration should generally be kept as low as possible so that the dye molecules do not change the freezing and melting properties of the alcohols in which they are dissolved or increase their viscosity. The dye concentration typically lies in a range of <10% by volume, in particular <1% or <0.1%, i.e. in the percent or parts per thousand or sub-parts per thousand range.

In one variant of the present invention, the threshold temperature to be monitored does not correspond directly to the melting temperature of the indicator substance, but rather that temperature above the melting temperature at which the viscosity of the melted substance has reduced to such an extent that the required liquid transport can take place.

This temperature is also referred to here as the threshold temperature and typically lies in a temperature range of 3-30° C. or 5-30° C., for example, 3-10° C., 3-20° C., 5-10° C. or 5-20° C., above the nominal melting temperature.

According to one advantageous embodiment, the indicator substance is therefore characterized in that the liquid mixture in a temperature range of 3-30° C. or 5-30° C. above the melting temperature has a viscosity in a range from 10 to 10⁶ mPa*s, preferably 10 to 10⁴ mPa*s.

According to one preferred embodiment, the region bearing the frozen-solid indicator substance comprises a coating, roughening and/or structuring. For example, the region bearing the frozen-solid indicator substance may comprise an adhesion-reinforcing structure coating. The adhesion of the frozen-solid indicator substance is improved as a result of this.

According to a further aspect, the region bearing the frozen-solid indicator substance may comprise a mirroring. According to this variant, the indicator substance is thus frozen solid on a mirrored region of the outer wall of the sample container. In the case of this embodiment, a change in configuration of the indicator substance can be particularly reliably detected by means of a measuring apparatus or purely visually.

According to a further aspect, the region bearing the frozen-solid indicator substance may comprise an electrode arrangement. The electrode arrangement may be embodied, for example, as a gold or platinum electrode. According to this variant, the indicator substance is thus frozen solid on the electrode arrangement in particular in such a manner that a resistance which can be measured via the electrode arrangement or an impedance depends on whether the indicator substance is located on the electrode arrangement or not. It can thus be determined on the basis of the measured resistance whether the indicator substance is still in the originally fitted frozen solid state on the electrode arrangement or whether the indicator substance has flowed out of the region of the electrode arrangement in the event of exceeding of its melting point as a result of it becoming liquid.

In addition to the sample container, a measuring apparatus may furthermore be provided which is formed to detect the resistance or the impedance of the electrode arrangement.

It is particularly advantageous if the indicator substance is applied in a predetermined arrangement onto the outer surface of the sample container. The indicator substance which is thus frozen solid at a region of the outer surface of the sample container may thus have a specific arrangement which changes when a melting temperature of the indicator substance is exceeded, e.g. under the influence of gravity. The arrangement may represent a number, a letter, a symbol, a marker and/or another structure which is visually easily apparent for a user. If the arrangement is clearly unchanged after cryogenic storage, the melting temperature of the indicator substance was not exceeded during cryogenic storage. If the arrangement has changed or has disappeared, it can be determined on this basis that the melting temperature and thus a critical threshold temperature was exceeded. A user can thus easily ascertain by a visual inspection whether an undesirable rise in temperature above the melting temperature or above the threshold temperature to be monitored has taken place.

According to a further aspect, the indicator substance applied on the outer surface may be obtained by frozen-solid drops of the indicator substance. This enables precise dosing of the indicator substance to be applied and a precise arrangement of the indicator substance, e.g. using a drop shooting device.

According to a further preferred embodiment, several different indicator substances, the different melting temperatures of which lie in each case in a range from −20° C. to −140° C., may be applied at different regions of the outer surface of the sample container. This has the advantage that several temperature threshold values may be monitored during cryogenic storage or that the achieved temperature intervals which the sample has reached can be more precisely restricted.

In the case of one advantageous variant of this configuration, the sample container is a cryogenic tube, and several different indicator substances which differ in terms of their melting temperatures are applied in each case on the form of frozen-solid drop in rows with respect to one another on a receiving cylinder of the cryogenic tube. The different indicator substances may in particular in each case be arranged in the form of drops arranged in band-form, for example, annularly, in rows with respect to one another on the outer surface of the receiving cylinder of the cryogenic tube, wherein the various indicator substances are arranged offset to one another in the axial direction of the cryogenic tube. This arrangement is visually easy to check for changes. The axial direction corresponds to the longitudinal direction of the cryogenic tube.

For example, it is possible to arrange the indicator substance deeper or higher in the axial direction, the lower its melting point is in comparison with the melting points of the other indicator substances. In other words, the different indicator substances may be arranged in the axial direction sorted according to their melting temperatures in falling or rising sequence. This enables a delimitation, which is particularly easy to carry out visually, of the temperature intervals which the sample stored in the sample container reaches.

According to a further embodiment of the invention, the frozen-solid indicator substance has at least at a sub-region of its surface a pattern or a surface structure, for example, a shaped or engraved pattern. A pattern or a surface structure disappears or changes at least upon liquefying of the indicator substance so that it is possible to check on the basis of the presence or absence of the sample whether the melting temperature was at least temporarily exceeded.

According to one advantageous variant of this embodiment, a transparent or semi-transparent protective cover may be arranged on the pattern and/or the surface structure. As a result, the pattern can be protected from external mechanical damage.

For example, the pattern or the surface structure may be an engraved pattern. An engraved pattern may be obtained, for example, by a shaping of the indicator substance in the liquid state in a mound and by subsequent freezing of the molded indicator substance.

According to a further aspect of the invention, a device for temperature monitoring of a cryopreserved biological sample is provided, comprising a sample container according to the invention, as described in this document, as well as a measuring apparatus which is formed to detect a change in configuration, in particular a change in form, arrangement and/or position, of the frozen-solid indicator substance.

The measuring apparatus may be embodied expediently according to the embodiment. In the case of the embodiment in which the region bearing the frozen-solid indicator substance has an electrode arrangement, the measuring apparatus may be formed to measure a resistance or an impedance of the electrode arrangement, as has already been described above.

In the case of the embodiment, in the case of which the region bearing the frozen-solid indicator substance comprises a mirroring, the measuring apparatus may, for example, be formed to direct a measuring beam, e.g. an electromagnetic beam, at the indicator substance which is frozen solid on the mirroring and detect a reflected measuring beam, if it is reflected. In the event of exceeding of the indicator substance, it will flow downwards in the liquid state on the sample container so that the measuring beam now strikes the mirrored surface directly, which surface was previously still covered by the frozen-solid indicator substance. The measuring beam is thus reflected on the mirrored surface, which can be detected by the measuring apparatus. Thus, as soon as the measuring apparatus detects a reflected measuring beam, it can be concluded that an at least brief exceeding of the melting temperature has taken place. In the case of the embodiment in which the frozen-solid indicator substance comprises a pattern or a surface structure, the measuring apparatus may be configured, for example, to optically detect whether the pattern or the surface structure is still present or not. In a similar manner, the measuring apparatus may be configured, for example, to detect whether the arrangement of the indicator substance is still present or not, etc.

The term sample container refers in particular to a container configured for cryopreservation. The sample container is preferably produced using low-temperature-compatible plastic material for temperatures below −140° C. The plastic material can tolerate repeated temperature changes without change and without damage. A plastic material is preferably used, the water absorbing capacity of which is <1% of the net mass, in particular <0.1% of the net mass. Cryogenic storage elements according to the invention are based, for example, on polyurethane or polyethylene.

The term “biological sample” refers to biological material such as cells, tissue, cell components, biological macromolecules, etc. which are subjected to cryopreservation in the sample container, where applicable, in a suspension and/or in combination with a substrate material. A substrate which is configured for adherent receiving of biological cells which are part of the biological sample may thus be arranged in the receiving space.

According to a further aspect of the invention, a method for producing a sample container which is configured for a temperature monitoring of a cryopreserved biological sample is provided. The method comprises providing a sample container which is configured for receiving a biological sample. The sample container is preferably a cryogenic sample container.

The method further comprises applying an indicator substance, the melting temperature of which lies in a range from −20° C. to −140° C., on a region of the outer surface of the sample container in the liquid state and freezing the applied indicator substance.

According to a first exemplary embodiment of the method, prior to application of the indicator substance in the liquid state, the sample container is cooled to a temperature below the melting temperature of the indicator substance. As a result, rapid freezing solid of the output indicator substance can be achieved.

For example, the indicator substance in the liquid state may be applied in drop form by means of a drop deposition device, e.g. a drop shooting device, onto the outer surface of the deep-frozen sample container. Drop shooting devices, embodied e.g. as a piezo pressure nozzle or piezo pressure head, are known per se from the prior art and are not described in greater detail here.

According to a second exemplary embodiment of the method, the application of the liquid indicator substance and the subsequent freezing are carried out according to the following steps:

Initially, partial immersion of the sample container in a container filled with an indicator substance in the liquid state is performed so that the indicator substance adheres to an outer side of the sample container at one point. Positioning the sample container on a hollow form is subsequently performed in such a manner that the indicator substance which adheres to the sample container fills out an embossment in the inner space of the hollow form. Once the indicator substance has been frozen in the hollow form, the hollow form is removed from the indicator substance frozen solid on the sample container. As a result of this, the embossment incorporated by the hollow form into a surface of the indicator substance is exposed.

According to a further aspect of the invention, a method for temperature monitoring of a cryopreserved biological sample is provided. The method comprises providing a sample container which is configured to receive a cryopreserved biological sample and which bears at a region of its outer surface a frozen-solid indicator substance, the melting temperature of which lies in a range from −20° C. to −140° C. The sample container may furthermore be embodied according to the embodiments and variants described in this document. In order to avoid repetition, features disclosed purely according to the device should also be regarded as disclosed according to the method and be capable of being claimed. The sample container may have a cryopreserved biological sample in its receiving space. The sample container may be stored at the storage temperature below the melting temperature of the indicator substance, for cryopreserved storage of the biological sample.

The method further comprises determining whether a change in configuration of the indicator substance performed by temporarily exceeding the melting temperature of the indicator substance has taken place, in particular whether a change in form or arrangement, in particular position, of the indicator substance has taken place. It is possible to determine on the basis of this change immediately by visual inspection or also in a technically automated manner whether the threshold temperature to be monitored was exceeded.

The preferred embodiments and features of the invention described above can be combined with one another. Further details and advantages of the invention are described below with reference to the enclosed drawings. In the drawings:

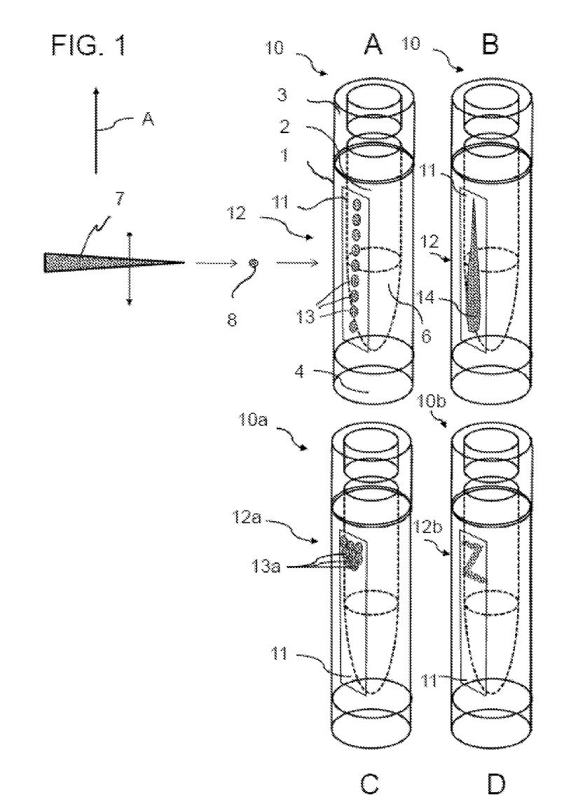

FIGS. 1-4 show schematic views of various exemplary embodiments of a sample container which is configured for temperature monitoring of a cryopreserved biological sample;

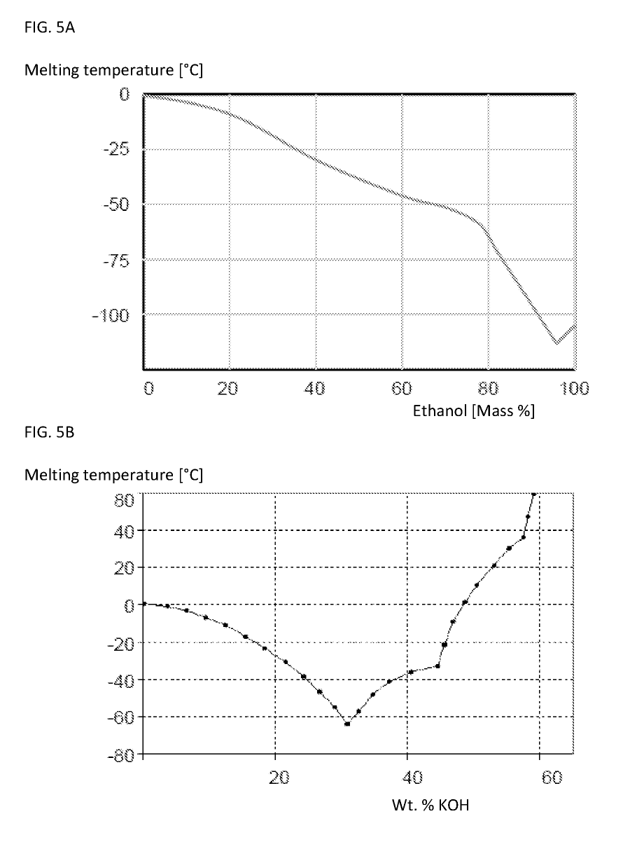

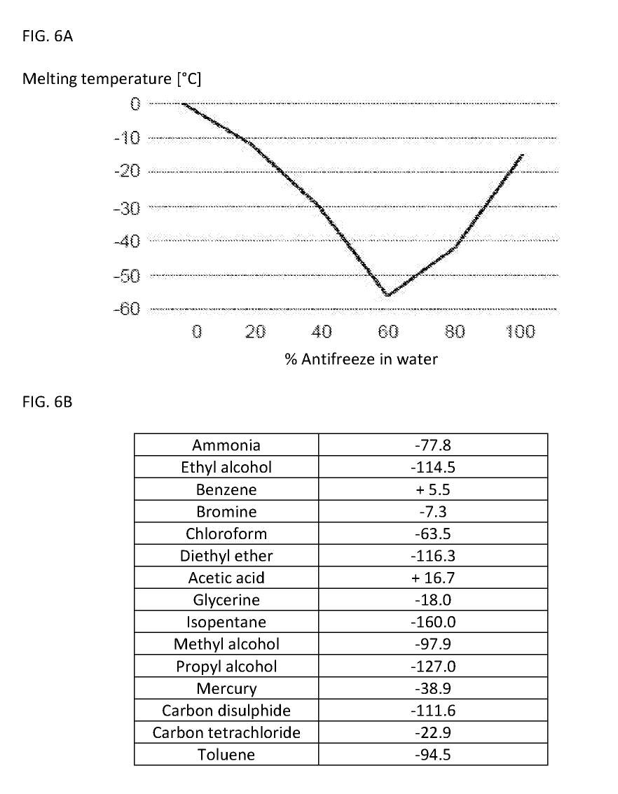

FIGS. 5A, 5B, 6A show in each case a melting diagram of a liquid mixture;

FIG. 6B shows a table with melting points of a number of pure liquids; and

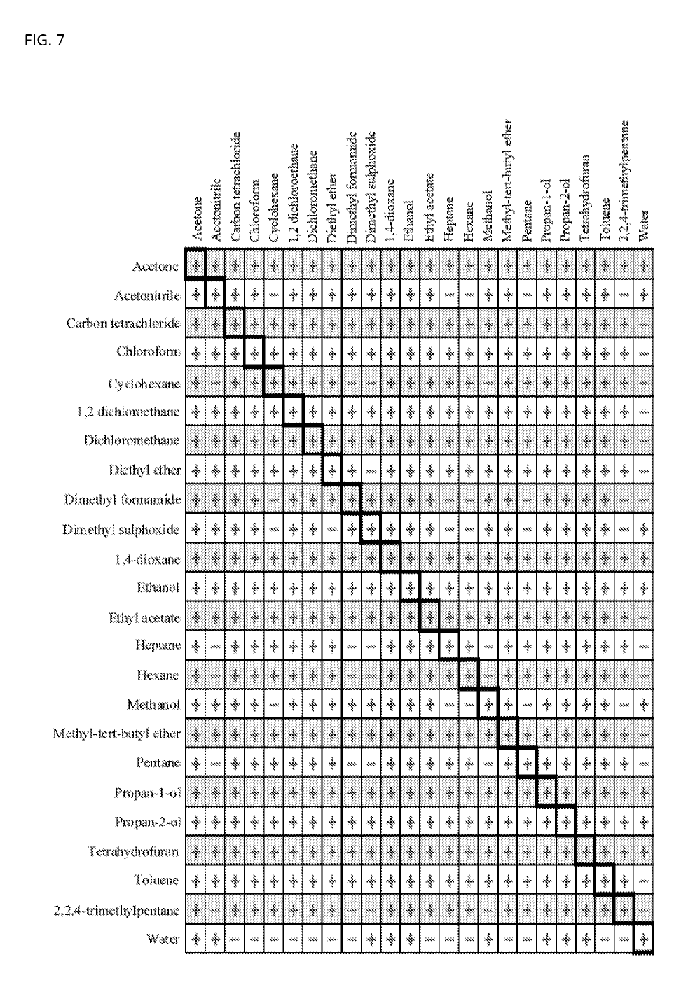

FIG. 7 shows a mixability matrix of solvents.

Identical elements or functionally equivalent elements are designated by the same reference numbers in all the figures and are partially not described separately.

FIG. 1A shows a first exemplary embodiment of a sample container 10 which is configured for temperature monitoring of a cryopreserved biological sample. FIG. 1A further illustrates the production of such a sample container 10 in a highly schematic manner.

Sample container 10 is a cryogenic tube which is represented in FIG. 1A in the fully screwed state. The cryogenic tube comprises a cylindrical receiving part 1 which forms a receiving space 2 in which a biological sample (biosample) 6 is stored. The biological sample can be a cell suspension. Cylindrical receiving part 1 is closed with a cover 3. The cryogenic tube furthermore has a base part 4.

Sample container 10 is already at the storage temperature in FIG. 1A, e.g. at −140° C., at least, however, below the melting point of indicator substance 8. The cryogenic tube bears at a region 11 of its outer surface a frozen-solid indicator substance 12, the melting temperature of which lies in a range from −20° C. to −140° C.

In this case, depending on the temperature threshold value which should be monitored during cryogenic storage, a suitable liquid or a liquid mixture should be selected as indicator substance 12.

Via the selection of suitable liquids and the mixture ratio of liquids, its melting point can be set to a desired value, in particular in a range from −20° C. to −140° C.

By way of example, FIG. 5A indicates the profile of the melting point as a function of the mixture ratio of an alcohol and water, with which, in the case of a moderate increase in viscosity with falling temperature, a temperature range between 0° C. and −118° C. can be covered. Should e.g. a temperature threshold value of −118° C. be monitored, the ethanol ratio can be set at 93.5%. Melting points up to a value of slightly below −60° C. can also be set by adding potassium hydroxide (KOH) to water, which is shown in FIG. 5B on the basis of a melting diagram. A mixture of water and antifreeze can also be used as an indicator substance, which is illustrated by the melting diagram of FIG. 6A. The table of FIG. 6B lists freezing points/melting points of further pure liquids which can be used on their own or as a mixture with another liquid as the indicator substance. Further liquid mixtures which are suitable as the indicator substance include chloroform/cyclohexane mixtures or other mixable liquids which can be inferred e.g. from the mixability matrix of solvents of FIG. 7.

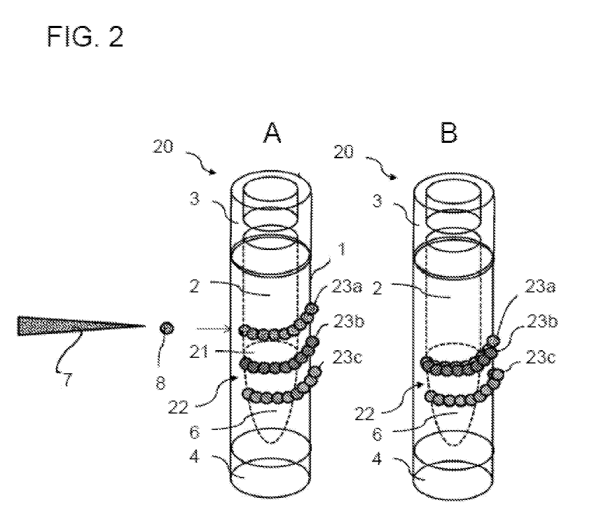

If several temperature threshold values are supposed to be monitored during cryogenic storage or if the achieved temperature intervals which the sample reaches should be restricted more precisely, several different indicator substances with different melting points can correspondingly be used, which is described below on the basis of FIG. 2.

Region 11 of the cryogenic tube shown in FIG. 1A bears indicator substance 12 in the form of frozen-solid drops 13 arranged in row-form in axial direction A (represented by the vertical arrow in FIG. 1).

Drops 13 of indicator substance 12 are applied as follows onto the cryogenic tube: warm or pre-cooled indicator substance 8 in the liquid state is shot in drops, e.g. via piezo pressure nozzles, onto the cold surface of region 11 of the cryogenic tube via a drop shooting device 7. Drops 8 freeze on the very cold surface, as represented in FIG. 1A by reference number 13.

In order to improve adhesion, surface region 11, which is provided to retain the indicator substance, can be changed in terms of its properties so that good wetting and adhesion of the drops are performed, e.g. by roughening region 11 and/or by applying a structure or chemical coating onto region 11.

Drops 13 solidify on the surface, as shown in FIG. 1A. If the cryogenic sample exceeds the melting temperature of indicator substance 8 at any time during storage, frozen drops 13 are then liquefied and flow fully or partially together. An image then emerges which is approximately the same as that represented in FIG. 1B.

If, after cryogenic storage, indicator substance 12 is no longer in the state shown in FIG. 1A, but rather in a state in which the drops have at least partially flowed together as illustrated schematically in FIG. 1B, it can be concluded from this that the melting temperature and thus a critical threshold temperature were exceeded. If, however, after cryogenic storage, an unchanged arrangement of the indicator substance is found, sample 6 has been properly stored continuously below the melting temperature.

A user can thus easily determine by visual inspection whether an undesirable rise in temperature above the melting temperature or above the threshold temperature to be monitored has taken place.

By means of the possibility of firing very fine drop systems with piezo systems, larger drop areas or also letters, patterns and rapidly recognizable structures as well as barcodes and other markers can also be generated on the surface of the sample container. These structures are lost if the critical temperature of the indicator substance is exceeded. Exemplary arrangements are represented in FIG. 1C and FIG. 1D.

FIG. 1C shows a sample container 10a which bears at a region 11 of its outer surface a frozen-solid indicator substance 12a which is formed from a larger drop area and/or several frozen drops 13a of indicator substance arranged regularly on top of one another and next to one another. FIG. 1D shows a sample container 10a which bears at a region 11 of its outer surface a frozen-solid indicator substance 12b which is applied in the form of a letter.

If the arrangement of indicator substance 12a or 12b is lost during cryogenic storage, in turn an at least temporary exceeding of the threshold temperature can be concluded.

FIG. 2A again shows a cryogenic tube 20 at the storage temperature and a drop shooting device 7.

In this example, as shown in FIG. 1A, a row of indicator substance drops 8 are applied annularly in band form onto a region 21 of the outer, very cold surface of cryogenic tube 1, where they freeze solid.

Various indicator substances 23a, 23b and 23c, the melting temperatures of which are different, are used in the exemplary embodiment of FIG. 2. Merely by way of example, indicator substance 23a can have a melting temperature of −60° C., indicator substance 23b a melting temperature of −70° C. and indicator substance 23c a melting temperature of −80° C. If one applies the various indicator substances as shown in FIG. 2A onto the cryogenic tube, wherein their melting temperatures reduce from top to bottom, in the event of one or more melting temperatures being exceeded, it can be recognized on the basis of the structure that an inadmissible rise in temperature has taken place.

FIG. 2B represents by way of example the case that only the melting temperature of indicator substance 23a (upper drop ring in FIG. 2A) was exceeded so that only the upper drop ring in FIG. 2B has flowed downwards, which in turn can be very easily detected from outside and does not contaminate the interior of the biological sample.

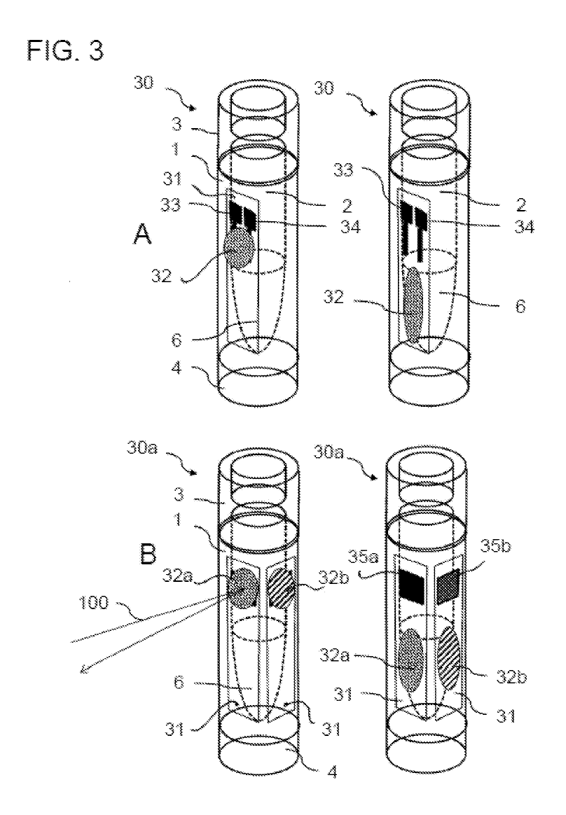

FIG. 3A shows, in the left-hand part of the figure, a cryogenic tube in an analogous manner to FIGS. 1 and 2, in the case of which an electrode arrangement 33, 34, e.g. in the form of miniaturized gold or platinum electrodes, is still located at region 31 of the outer surface onto which indicator substance 32 is applied.

If the melting temperature of indicator substance 32 is exceeded, it flows out of the electrode region, as a result of which the resistance or the impedance changes, which can be detected by scanning of electrodes 33, 34. A state of cryogenic tube 30, in the case of which the melting temperature of indicator substance 32 was exceeded, is shown in the right-hand part of the figure in FIG. 3A.

Illustration 3B shows an embodiment of cryogenic tube 30a in the case of which in each case a mirrored surface 35a, 35b is located on two regions 31 of the outer surface of the cryogenic tube, onto which mirrored surface 35a, 35b indicator substance 32a, 32b is applied. It can be ascertained optically, visually or via a measuring beam 100 whether indicator substance 32a, 32b is still located on these original position fields on mirrored surface 35a, 35b. If this is the case, the melting temperature of the indicator substance has not been exceeded. In contrast, the right-hand part of the figure of FIG. 3B shows a state in which indicator substance 32a, 32b has left this region as a result of melting and flowing away. The conclusion can thus be drawn here of an exceeding of the melting temperature which has occurred in the interim and thus of the threshold temperature to be monitored.

Moreover, different indicator substances can be selected so that indicator substance 32a on first mirrored surface 35a has a melting temperature which corresponds to a first temperature threshold value to be monitored and that indicator substance 32b on second mirrored surface 35b has a melting temperature which corresponds to a second temperature threshold value to be monitored.

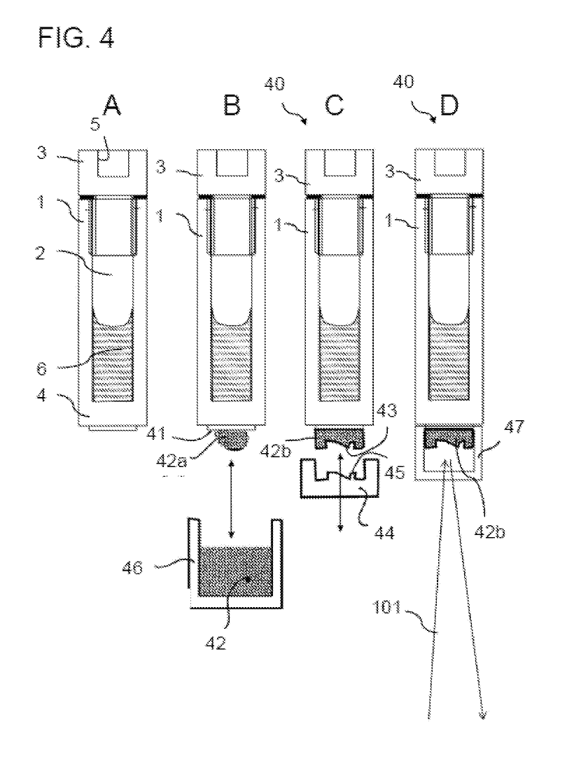

FIG. 4 schematically illustrates, in the chronological sequence of FIGS. 4A, 4B, 4C, and 4D, the production of a further cryogenic tube 40 which is configured for temperature monitoring of a cryopreserved biological sample.

A sample container in the form of a typical closed cryogenic tube 1, as is used in cryogenic biobanks, is shown in a sectional view in FIG. 4A. It generally comprises a receiving volume 2 for the biosample in which the biomaterials are located. The biosample is e.g. here a cell suspension 6. The cryogenic tube further comprises a cover 3 which closes off the vessel and has an engagement 4 at the top via which cover 3 can be rotated with a tool (not shown) in the case of automation. Said cryogenic tube 1 can also contain a base 4 into which a barcode rectangle or another marker is optionally inserted. In this form, usually standing vertically in receptacles, cryogenic tubes 1 are stored in the low-temperature containers.

The cryogenic tube can be at a temperature between room temperature and just above the melting point of indicator substance 42. This is present in liquid form in a container 46 into which base 4 of the cryogenic tube, as shown in FIG. 4B, is immersed.

As a result of this, part 42a of indicator substance 42 in liquid form is present at base 4. The cryogenic tube with indicator substance quantity 42a is thus pushed into a structured mound 44 and brought to the storage temperature. As a result, indicator substance 42b assumes the surface structure and embossment 45 of the inner space of mound 44 in an inverse manner.

Cryogenic tube 40 shown in FIG. 4C thus bears on its underside a frozen-solid indicator substance which has at a sub-region of its surface an engraved pattern 43 or a surface structure. For protection during further storage, this solidified structure is covered with a cap 47 which can be embodied e.g. to be optically transparent so that an automatic identification of the structure can be checked via a camera system or an optical measuring beam 101.

If pattern 43 engraved in indicator substance 42b or the incorporated structure is lost or changes, the cryogenic tube has been brought again above the melting temperature of indicator substance 42b at some point in time. Cryogenic tube 40 is thus configured for temperature monitoring of a cryopreserved biological sample.

It is subsequently possible to check by means of frozen-solid indicator substance 42b at any desired point in time during the storage process whether an undesirable, if only temporary heating of the cryosample has taken place. To this end, a check is made as to whether pattern 43 engraved into indicator substance 42b has been lost or has changed. If this is the case, an exceeding of the threshold temperature(s) to be monitored can be concluded.

If one generates a structure in which a flowing or group-type transition from very fine to coarser structure elements is realized, even a very brief exceeding of the melting point can be detected via the changes in the structure. The geometrically smallest and finest structures change first.

Although the invention has been described with reference to specific exemplary embodiments, it is apparent for a person skilled in the art that various changes can be made and equivalents can be used as a replacement without departing from the scope of the invention. The invention should consequently not be restricted to the disclosed exemplary embodiments, but rather should enclose all the exemplary embodiments which fall into the scope of the enclosed claims. In particular, the invention also claims protection for the subject matter and the features of the subordinate claims independently of the claims referred to.

1. A sample container which is configured to receive a cryopreserved biological sample, which bears at a region of an outer surface thereof a frozen-solid indicator substance, the melting temperature of which lies in a range from −20° C. to −140° C.

2. The sample container according to claim 1, wherein a region bearing the frozen-solid indicator substance comprises a coating, a roughening and/or a structuring.

3. The sample container according to claim 1, wherein the region bearing the frozen-solid indicator substance comprises a mirroring.

4. The sample container according to claim 1, wherein the region bearing the frozen-solid indicator substance comprises an electrode arrangement.

5. The sample container according to claim 1, wherein the indicator substance is applied in a predetermined arrangement onto the outer surface of the sample container, wherein the predetermined arrangement represents a number, a letter, a symbol, a marker and/or a structure.

6. The sample container according to claim 1, wherein the indicator substance applied on the outer surface is obtained by frozen-solid drops of the indicator substance.

7. The sample container according to claim 1, wherein several different indicator substances, have different melting temperatures which lie in each case in a range from −20 C. to −140° C., are applied at different regions of the outer surface of the sample container.

8. The sample container according to claim 1, which is a cryogenic tube.

9. The sample container according to claim 8, wherein
a) several different indicator substances which differ in terms of their melting temperatures are applied in each case in a form of frozen-solid drops in rows with respect to one another on a receiving cylinder of the cryogenic tube, and
b) the indicator substances are arranged offset to one another in an axial direction of the cryogenic tube.

10. The sample container according to claim 1, wherein the frozen-solid indicator substance comprises at least at a sub-region of a surface thereof a pattern or a surface structure.

11. The sample container according to claim 10, wherein the pattern or the surface structure is an engraved pattern.

12. A device for temperature monitoring of a cryopreserved biological sample, comprising
a sample container according to claim 1; and
a measuring apparatus which is formed to detect a change in configuration of the frozen-solid indicator substance, wherein the change in configuration is at least one member selected from the group consisting of a change in form, a change in arrangement and a change in position.

13. A method for producing a sample container which is configured for a temperature monitoring of a cryopreserved biological sample, comprising
providing a sample container for receiving a biological sample; and
applying an indicator substance, the melting temperature of which lies in a range from −20° C., to −140° C., on a region of an outer surface of the sample container in a liquid state; and
freezing the applied indicator substance

14. The method according to claim 13, wherein prior to the applying of the indicator substance in the liquid state, the sample container is cooled to a temperature below the melting temperature of the indicator substance

15. The method according to claim 13, wherein the indicator substance is applied in drop-form by a drop deposition device on the outer surface of the sample container.

16. The method according to claim 13, further comprising
a) partial immersion of the sample container in a container filled with an indicator substance in the liquid state so that the indicator substance adheres to an outer side of the sample container at one point;
b) positioning the sample container on a hollow form in such a manner that the indicator substance which adheres to the sample container fills out an embossment in an inner space of the hollow form; and
c) after the indicator substance is frozen, removing the hollow form from the indicator substance frozen solid to the sample container.

17. A method for temperature monitoring of a cryopreserved biological sample, comprising the steps:
a) providing a sample container according to claim 1; and
b) determining whether a change in shape or arrangement of the indicator substance performed by temporarily exceeding the melting temperature of the indicator substance or a threshold temperature at which a viscosity of melted indicator substance undershoots a specific target value has taken place.

18. A sample container according to claim 1, wherein the indicator substance comprises at least one alcohol selected from the group consisting of octan-1-ol, nonan-1-ol, propane-1,2-diol, propane-1,3-diol, butane-1,2-diol, butane-1,3-diol, butane-2-ol, pentane-1,5-diol, pentan-1-ol, cyclopentanol, and benzyl alcohol as well as optionally at least one dye.

19. The sample container according to claim 18, wherein the dye is selected from the group consisting of triphenylmethane dyes, rhodamine dyes, azo dyes, phenazine dyes and phenothiazine dyes.

20. The sample container according to claim 18, wherein the indicator substance comprises at least two alcohol components selected from the group consisting of octan-1-ol, nonan-1-ol, propane-1,2-diol, propane-1,3-diol, butane-1,2-diol, butane-1,3-diol, butane-2-ol, pentane-1,5-diol, pentan-1-ol, cyclopentanol, and benzyl alcohol and/or the indicator substance comprises at least one dye selected from the group consisting of oil red, methyl red, brilliant green, rhodamine B, neutral red, and methylene blue.
